(19) United States
(12) Patent Application Publication
(10) Pub. No.: US 2026/0214056 A1
(43) Pub. Date: Jul. 23, 2026

(54) METHOD, APPARATUS, DEVICE, AND STORAGE MEDIUM FOR ANALYZING DATA

(71) Applicant: Lemon Inc., Grand Cayman (KY)

(72) Inventor: Yuchen Zhang, Beijing (CN)

(21) Appl. No.: 19/139,814

(22) PCT Filed: Dec. 12, 2023
(86) PCT No.: PCT/SG2023/050826

§ 371 Date: Jun. 16, 2025

(30) Foreign Application Priority Data
Dec. 16, 2022 (CN) 202211626925.8

(51) Int. Cl. H04L 47/2441; H04L 43/026

(52) U.S. Cl. CPC H04L 47/2441; H04L 43/026

(57) ABSTRACT

The embodiment of the disclosure provides a method, an apparatus, a device and a computer readable storage medium for analyzing data. In the method, a link of a called node associated with a first node is determined, wherein a target type of data flows through the first node; data traffic on the link is obtained; and a field associated with the target type of data in the data traffic is detected, to determine a flow direction of the target type of data on the link. In this way, the target type of data can be effectively tracked from the holistic perspective.

This application claims the priority to Chinese Patent Application No. 202211626925.8, filed Dec. 16, 2022 and entitled “METHOD, APPARATUS, DEVICE, AND STORAGE MEDIUM FOR ANALYZING DATA”, the entirety of which is incorporated herein by reference.

### FIELD

The example embodiments of the present disclosure generally relate to data analysis, and more particularly, to methods, apparatuses, devices, and computer-readable storage medium for analyzing data.

### BACKGROUND

Data analysis may be applied to various industries, including finance, automobiles, catering, telecommunications, and entertainment, and so on. By analyzing the data, useful information directing human production and life can be extracted. Data governance is an important aspect of data analysis. Data governance may include operations such as collection, transmission, storage, access, sharing, destruction and the like for data. Through data governance, data security, accuracy, availability and ease of use can be ensured. For example, governance of user data may protect the security of user data throughout the data lifecycle.

In a data governance process, it is often necessary to determine an association between data, also referred to as a “data lineage”. The data lineage may describe the flow behavior of the data throughout the system. It is desirable to efficiently analyze the complete flow direction of data.

### SUMMARY

In a first aspect of the present disclosure, a method of analyzing data is provided. The method comprises: determining a link of a called node associated with a first node, wherein a target type of data flows through the first node; obtaining data traffic on the link; and detecting a field associated with the target type of data in the data traffic, to determine a flow direction of the target type of data on the link.

In a second aspect of this disclosure, an apparatus for analyzing data is provided. The apparatus comprises: a link analysis module configured to determine a link of a called node associated with a first node, wherein a target type of data flows through the first node; a traffic obtaining module configured to obtain data traffic on the link; and a flow direction calculation module configured to detect a field associated with the target type of data in the data traffic, to determine a flow direction of the target type of data on the link.

In a third aspect of this disclosure, an electronic device is provided. The electronic device comprises: at least one processing unit; and at least one memory coupled to the at least one processing unit and storing instructions for execution by the at least one processing unit. The instructions, when executed by the at least one processing unit, cause the electronic device to perform a method according to the first aspect of this disclosure.

In a fourth aspect of this disclosure, a computer-readable storage medium is provided. The computer-readable storage medium has a computer program stored thereon, and the computer program may be executed by a processor, to implement the method according to the first aspect of this disclosure.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of the various implementations of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIG. 2 shows a flowchart of a method of analyzing data according to some embodiments of the present disclosure;

FIG. 3 illustrates a schematic diagram of an example architecture of a system for analyzing data according to some embodiments of the present disclosure;

FIG. 4 illustrates a schematic diagram of an example operation process of a system for analyzing data according to some embodiments of the present disclosure;

FIG. 5 shows a schematic structural block diagram of an apparatus for analyzing data according to some embodiments of the present disclosure; and

FIG. 6 shows a block diagram of an electronic device that can be used to implement some embodiments of the present disclosure.

### DETAILED DESCRIPTION

The embodiments of the present disclosure will be described in more detail below with reference to the accompanying drawings. While some embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for illustrative only and are not intended to limit the scope of the present disclosure.

In the description of the embodiments of the present disclosure, the terms “comprise” and the like should be understood as open terms that mean “include, but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

The term “in response to” means that a corresponding event occurs or condition is satisfied. It will be appreciated that the timing of execution of subsequent actions performed in response to the event or condition is not necessarily strongly correlated with the timing at which the event occurs or the condition is satisfied. In some cases, subsequent actions may be performed immediately after an event occurs or a condition holds; in other cases, subsequent actions may also be performed in a period of time after an event occurs or a condition holds.

It may be understood that the data involved in the technical solution (including but not limited to the data itself, the obtaining or use of the data) should follow the requirements of the corresponding laws and related regulations.

It can be understood that, before the technical solutions disclosed in the embodiments of the present disclosure are used, the types, the usage scope, the usage scenario and the like of personal information related to the present disclosure should be notified to the user in an appropriate manner according to the relevant laws and regulations, and the authorization of the user may be obtained.

For example, in response to receiving an active request from a user, prompt information is sent to the user to explicitly prompt the user that the requested operation will need to obtain and use personal information of the user, so that the user can autonomously select whether to provide personal information to software or hardware executing the operation of the technical solution of the present disclosure according to the prompt information.

As an optional but non-limiting implementation, in response to receiving an active request of the user, a manner of sending prompt information to the user may be, for example, a pop-up window, and prompt information may be presented in a text in the pop-up window. In addition, the pop-up window may further carry a selection control for the user to select “agree” or “disagree” to provide personal information to the electronic device.

It may be understood that the foregoing notification and obtaining a user authorization process are merely illustrative, and do not constitute a limitation on implementations of the present disclosure, and other manners meeting related laws and regulations may also be applied to implementations of the present disclosure.

The term “service” as used herein refers to an application, program, module, process, thread, or the like that can be configured to implement a particular function or perform a particular operation at runtime. One service may implement one or more functions.

As mentioned above, with data governance, data security, accuracy, availability, and ease of use can be ensured. In the era of big data, the source of data is extremely wide, various types of data are rapidly generated and explosively increased, which results in increasingly complex relationships among data. In a data governance process, it is often necessary to determine an association between data, also referred to as a “data lineage”. The data lineage may describe the flow behavior of the data in the whole system, for example, how the data flows to the downstream service and storage after being collected, and how the data flows out from the storage, and is accessed by other services, and so on.

The data lineages in granularity of service and function (also referred to as method) can be figured out with data lineage analysis techniques. For example, function 1 of service A calls function 2 of service B, which in turn calls storage C and writes data. However, it cannot be determined at present what type of data is specifically transmitted to the service B by the service A. For some type of data, a complete flow direction of data cannot be figured out in an efficient way.

The embodiments of the present disclosure provide a solution of analyzing data for tracking a target type of data. In some embodiments, a field lineage analysis scheme based on traffic analysis may be employed. For example, traffic may be acquired on a processing node and a storage node that may be involved in a service link through tracking of data inflow and outflow nodes, to obtain data traffic transmitted among the services, and determine a data flow direction in the dimension of a data type by analyzing the data. In this way, it is possible to determine which interfaces will reveal the target type of data by analyzing the target field transmission and storage links, how these data will flow, ultimately into which stores, what data is derived, etc., thus a trusted data flow graph can be provided.

The solution may provide effective data support in the data governance process, and may be applied to many scenarios. For example, in a scenario of managing and controlling user data access, if an outflow node of user data is found, a permission management and control policy may be set at this node to converge access to user data. In a scenario of user data governance, if an upstream access party of a data storage node is found, link tracking for a user data outflow scenario may be constructed. Thus, the target type of data can be tracked from the holistic perspective.

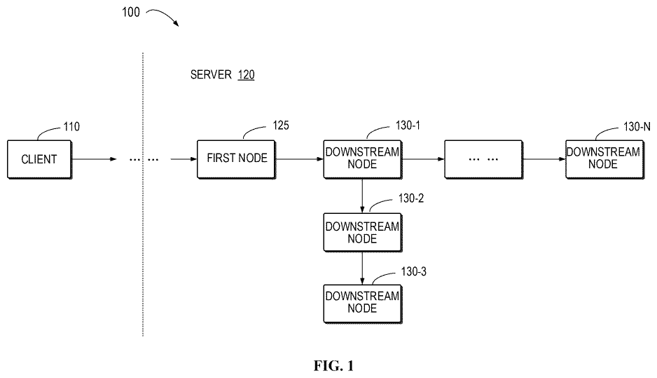

FIG. 1 illustrates a schematic diagram of an example environment 100 in which embodiments of the present disclosure can be implemented.

As shown in FIG. 1, in the environment 100, the client 110 may initiate a request for a service to the server 120. The service may comprise a remote procedure call (RPC) service or any other suitable service.

The client 110 may be any type of device, including virtual and physical devices. By way of example, the client 110 may comprise, but is not limited to, a mobile device, a fixed device or a portable device, and/or the like, such as a cell phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an e-book device, a virtual reality (VR) all-in-one machine, a game console, a game computer, or any combination of the foregoing, including accessories and peripherals of these devices, or any combination thereof. In some embodiments, the client 110 may also support any type of interface for a user (such as a “wearable” circuit, etc.).

The server 120 may comprise a plurality of nodes, including a service node having a service function and a storage node having a storage function. Each node may implement a corresponding function using its code repository. A node may be implemented by any type of device, including virtual and physical devices. Examples of such devices may comprise, but are not limited to, mainframes, edge computing nodes, rack servers, router computers, server computers, personal computers, mainframe computers, laptop computers, tablet computers, desktop computers, and the like. In some embodiments, the device may comprise a virtual machine, a container, or a bare metal server.

In response to the request of the client 110, the first node 125 of the server 120 and the plurality of nodes 130-1, 130-2, 130-3, . . . 130-N downstream thereof may be called, where N is any suitable positive integer. In operation, the target type of data flows through the first node 125. For example, the target type of data flows out from the first node 125, or the first node 125 accesses a storage node of the target type of data. In the context of the present disclosure, the type of data may be associated with any suitable classification of data accessed or transmitted in a service. As an example, the target type of data may be some type of user data.

At the server 120, a dedicated management node (not shown) may be arranged for data tracking. Alternatively or additionally, a service node or a storage node may serve as the management node. In order to determine the flow direction of the target type of data, according to an embodiment of the present disclosure, traffic is obtained on the called link associated with the first node 125, and a field associated with the target type of data is detected in the obtained data traffic. Therefore, the flow direction of the data in field dimension may be obtained.

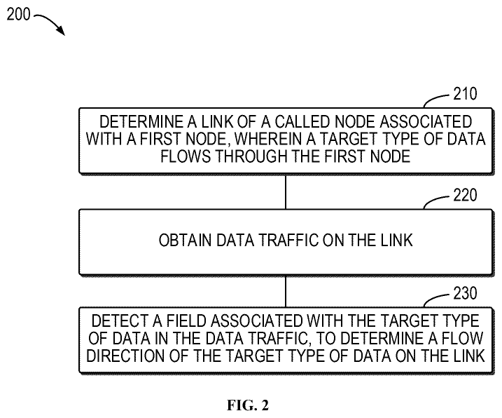

FIG. 2 shows a flowchart of a method 200 of analyzing data according to some embodiments of the present disclosure. The method 200 may be performed by a node for data tracking at the server 120. For ease of discussion, the method 200 will be described in conjunction with FIG. 1.

At block 210, a link of the called node associated with the first node 125 is determined. For example, after it is determined that the first node 125 has accessed or output the target type of data, link information about the first node 125 is determined, including explicitly accessed and possibly accessed nodes. The explicitly accessed nodes may be obtained by link tracing (e.g., trace). Alternatively or additionally, considering that a call between services may not convey contextual information, making it difficult to trace the complete link, nodes that are likely to be accessed by the service may be obtained by monitoring and event-tracking (e.g., metrics) to further enhance the efficiency of link tracking.

At block 220, data traffic on the link is obtained. For example, drainage acquisition of data may be performed for nodes on the link, whereby the acquired traffic samples may be used for calculating flow direction of data. As an example, a traffic sample may be obtained by detecting a binary sample of traffic from a network card using a drainage plugin, and parsing the same according to a service protocol. The examples of service protocols may include, but are not limited to, Hyper Text Transfer Protocol (HTTP), THRIFT, Mysql, Redis, and the like. The traffic may be captured in real time, and the captured data may be forwarded through a message queue (MQ) for downstream consumption.

In the traffic acquisition operation, the input may be the service name list of each node, and the output may be parsed traffic sample information. In some embodiments, a traffic sample associated with a node on the link (referred to as a “second node”) may comprise at least one of a request, a response, a calling party, a service name (e.g., PSM), a function, a path (e.g., in the case of using HTTP) associated with the second node.

At block 230, a field associated with the target type of data is detected in the data traffic to determine a flow direction of the target type of data on the link. For example, the collected traffic samples may be joined into sample information for different services on the once call chain. Then, the delivery of concerned field between the upstream and downstream is analyzed to construct a lineage in dimension of field.

In some embodiments, the call link obtained by link analysis may comprise a link of a node called in response to a user request. By detecting an identifier (for example, logid) of the user request in the data traffic, a transmission link of the identifier of the user request may be determined as the link of the node called in response to the user request. Then, the field associated with the target type of data may be detected on the transmission link. A request identifier, such as a logid, generated by the framework of the service, may be passed with the call. As such, the same logid may be considered an once request chain. According to the service name (for example, the PSM) of the called party and the calling party, the transmission link of the logid can be constructed, so that the traffic generated between different services may be determined on the once online call. Therefore, the flow link in dimension of field may be constructed by analyzing the passing relationship (for example, passthrough, encryption and decryption, etc.) of the fields in the traffic samples.

In some embodiments, a field associated with the target type of data may be detected in the data traffic, based on the value of the target field associated with the target type of data in the first node 125. For example, after it is determined that the target type of data flows through the first node 125, the field in the first node 125 that is associated with the target type of data may be used as the target field. The flow condition in the target field may be determined by matching the value of the target field with that of field in other nodes in the traffic sample.

In some embodiments, if it is determined that the target type of data flows through the second node on the link, information about the second node and a field associated with the target type of data in the second node may be stored. In some embodiments, the information may be stored in the graph storage database in the form of a graph. Such a lineage map may be queried in a visual query platform.

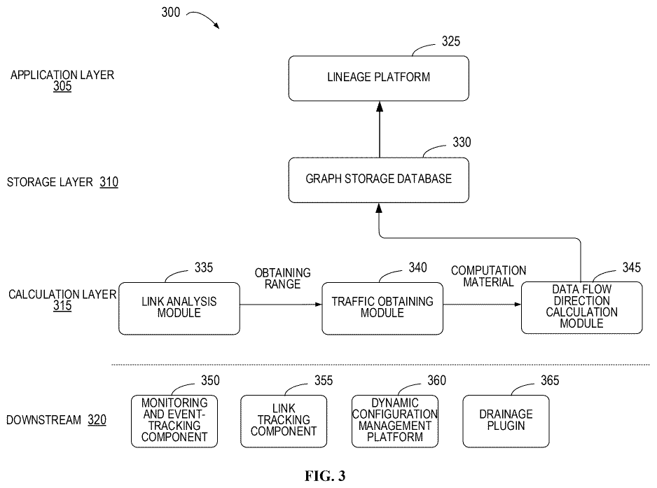

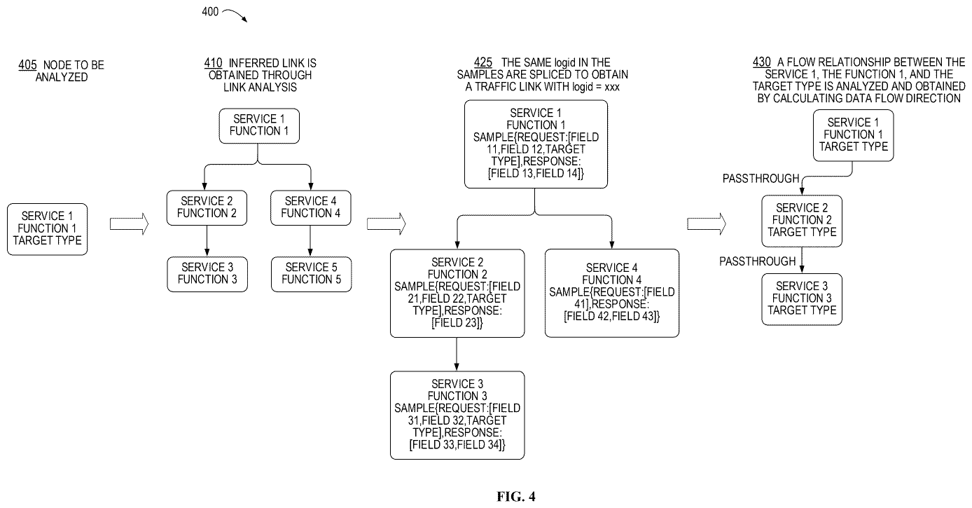

An example process for data analysis according to some embodiments of the present disclosure will be discussed below with reference to FIGS. 3 and 4.

Reference is first made to FIG. 3, which shows a schematic diagram of an example architecture of a system 300 for analyzing data according to some embodiments of the present disclosure.

As shown in FIG. 3, the system 300 for analyzing data may comprise an application layer 305, a storage layer 310, a calculation layer 315, and a downstream 320. The application layer 305 may comprise a lineage platform 325, which may be implemented as a front-end platform for a lineage map visualization query. The storage layer 310 may comprise a graph storage database 330, which may store the flow direction graph calculated through the flow direction of data in the form of a graph. The computing layer 315 may comprise a link analysis module 335, a traffic obtaining module 340, and a data traffic calculation module 345. These three modules are in close cooperation, and the output of the former may be the input for the latter. The downstream 320 may comprise a monitoring and event-tracking component 350, a link tracking component 355, a dynamic configuration management platform 360, and a drainage plugin 365.

FIG. 4 shows a schematic diagram of an example operation process 400 of the system 300 for analyzing data according to some embodiments of the present disclosure.

In process 400, at 405, a node to be analyzed, such as first node 120, is determined. The analysis goal may be a service 1+function 1. At 410, a inferred link is obtained through link analysis. For example, the input may be a service name +function name+field. The output is a inferred call link, including, for example, service 1+function 1-->service 2+function 2-->service 3+function 3, and service 1+function 1-->service 4+function 4-->service 5 +function 5. The call link may be inferred by link tracking and monitoring and event-tracking.

At 425, the traffic samples with the same logid (e.g., denoted xxx) in the traffic samples are spliced to obtain a traffic link with logid=xxx. In this way, the processing nodes and storage nodes that may be involved in one user request may be concatenated with logid. In operation, the input may be a series of service samples. The output may be the lineage link with respect to a certain field in the same logid, for example: for logid=id1, the following traffic link is acquired at a certain period: service 1+function 1-->service 2+function 2-->service 3+function 3, wherein service 1+function 1 has field 1 of interest.

At 430, a flow relationship between the service 1, the function 1, and the target type is analyzed and obtained by calculating data flow direction. For example, the following passthrough action is found through analysis: service 1+function 1 (field 1)-->service 2+function 2 (field 2)-- >service 3 +function 3 (field 3). Then, the following link is generated: service 1 +function 1+field 1--passthrough-->service 2+function 2+field 2---passthrough-->service 3+function 3+field 3.

In this way, the flow relationship of data may be found from the field dimension. Through real-time collection and calculation of online data, higher accuracy can be guaranteed. In sensitive data leakage and control scenarios, a field that needs to be treated can be accurately located, and accurate data flow direction information is provided.

In some embodiments, a filed lineage analysis schema based on a code analysis may be employed. For example, the field query database may be constructed based on the code warehouse of each node in the tracking link, the situation of the flow of the specified field to the downstream service and storage is analyzed by the database query, and the flow direction of data in the field dimension is finally determined. In this way, if an outflow or access node of a certain type of data is found, the data may be effectively tracked by constructing a trace of this type of data outflow scenario.

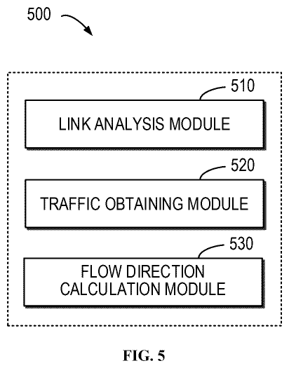

FIG. 5 shows a schematic structural block diagram of an apparatus 500 for analyzing data according to some embodiments of the present disclosure. The apparatus 500 may be implemented at the service 120 in FIG. 1.

As shown in FIG. 5, the apparatus 500 comprises a link analysis module 510, a traffic obtaining module 520, and a flow direction calculation module. The link analysis module 510 may be an example implementation of link analysis module 335 in FIG. 3, it is configured to determine a link of a called node associated with the first node, wherein the target type of data flows through the first node. The traffic obtaining module 520 may be an example implementation of the traffic obtaining module 340 in FIG. 3, it is configured to obtain data traffic on the link. The flow direction calculation module 530 may be an example implementation of the flow direction calculation module 345 in FIG. 3, it is configured to detect a field associated with the target type of data in the data traffic, to determine a flow direction of the target type of data on the link.

In some embodiments, the link may comprise a link of a node called in response to a user request.

In some embodiments, the flow direction calculation module 530 may be configured to detect an identifier of the user request in the data traffic, to determine a transmission link of the identifier of the user request as the link of the node called in response to the user request; and detect the field associated with the target type of data on the transmission link.

In some embodiments, the data traffic may comprise a traffic sample associated with a second node on the link. The traffic sample comprises at least one of a request, a response, a calling party, a service name, a function or a path associated with the second node.

In some embodiments, the flow direction calculation module 530 may be configured to detect the field associated with the target type of data in the traffic sample.

In some embodiments, the flow direction calculation module 530 may be configured to detect the field associated with the target type of data in the data traffic, based on a value of a target field associated with the target type of data in the first node.

In some embodiments, the apparatus 500 may further comprises a storage module, the example of which may be the graph storage database in FIG. 3. The storage module may be configured to, in response to determining that the target type of data flows through a second node on the link, store information about the second node and a field associated with the target type of data in the second node.

It should be understood that the features related to the data analysis operation discussed above with reference to FIG. 1 to FIG. 4 and the corresponding effects are also applicable to the apparatus 500, and details are not repeated here.

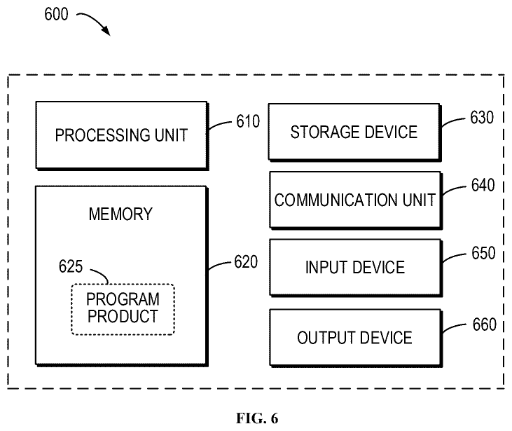

FIG. 6 illustrates a block diagram of an electronic device 600 in which one or more embodiments of the present disclosure may be implemented. For example, the electronic device 600 may be configured to implement a data analysis process according to an embodiment of the present disclosure. The electronic device 600 shown in FIG. 6 is merely an example and does not constitute any limitation on the functionality and scope of the embodiments described herein.

As shown in FIG. 6, the electronic device 600 is in the form of a general-purpose electronic device. Components of the electronic device 600 may comprise, but are not limited to, one or more processors or processing units 610, a memory 620, a storage device 630, one or more communication units 640, one or more input devices 650, and one or more output devices 660. The processing unit 610 may be an actual or virtual processor and capable of performing various processes according to programs stored in the memory 620. In multiprocessor systems, multiple processing units execute computer-executable instructions in parallel to improve parallel processing capabilities of electronic device 600.

The electronic device 600 typically comprises a plurality of computer storage media. Such media may be any available media accessible to the electronic device 600, including, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 630 may be a removable or non-removable medium and may include a machine-readable medium, such as a flash drive, magnetic disk, or any other medium, which may be capable of storing information and/or data (e.g., training data for training) and may be accessed within electronic device 600.

The electronic device 600 may further comprise additional removable/non-removable, volatile/non-volatile storage media. Although not shown in FIG. 6, a disk drive for reading or writing from/to a removable, nonvolatile magnetic disk (e.g., a “floppy disk”) and an optical disk drive for reading or writing from/to a removable, nonvolatile optical disk may be provided. In these cases, each drive may be connected to a bus (not shown) by one or more data media interfaces. The memory 620 may comprise a computer program product 625 having one or more program modules configured to perform various methods or actions of various embodiments of the present disclosure.

The communication unit 640 is configured to communicate with another electronic device through a communication medium. Additionally, the functionality of components of the electronic device 600 may be implemented in a single computing cluster or multiple computing machines capable of communicating over a communication connection. Thus, the electronic device 600 may operate in a networked environment using logical connections with one or more other servers, network personal computers (PCs), or another network node.

The input device 650 may be one or more input devices, such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, external devices such as storage devices, display devices, etc., communicate with one or more devices that enable a user to interact with the electronic device 600, or communicate with any device (e.g., a network card, a modem, etc.) that enables the electronic device 600 to communicate with one or more other electronic devices. Such communication may be performed via an input/output (I/O) interface (not shown).

According to example implementations of the present disclosure, there is provided a computer-readable storage medium having one or more computer instructions stored thereon, wherein one or more computer instructions are executed by a processor to implement the method described above.

Aspects of the present disclosure are described herein with reference to flowcharts and/or block diagrams of methods, apparatuses (systems), and computer program products implemented in accordance with the present disclosure. It should be understood that each block of the flowchart and/or block diagram, and combinations of blocks in the flowcharts and/or block diagrams, may be implemented by computer-readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means for implementing the functions/acts specified in one or more blocks in the flowchart and/or block diagram. These computer-readable program instructions may also be stored in a computer-readable storage medium, which cause the computer, programmable data processing apparatus, and/or other devices to function in a particular manner, such that the computer-readable medium storing instructions includes an article of manufacture including instructions to implement aspects of the functions/acts specified in one or more blocks in the flowchart and/or block diagram.

The computer-readable program instructions may also be loaded onto a computer, other programmable data processing apparatus, or other device, such that a series of operational steps are performed on a computer, other programmable data processing apparatus, or other device to produce a computer-implemented process, such that the instructions executed on a computer, other programmable data processing apparatus, or other device implement the functions/acts specified in the one or more blocks in flowchart and/or block diagram.

The flowchart and block diagrams in the drawings show architecture, functionality, and operation of possible implementations of systems, methods, and computer program products according to various implementations of the present disclosure. In this regard, each block in the flowchart or block diagram may represent a module, program segment, or portion of instructions that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the implementations disclosed herein.

1. A method of analyzing data comprising:
determining a link of a called node associated with a first node, wherein a target type of data flows through the first node;
obtaining data traffic on the link; and
detecting a field associated with the target type of data in the data traffic, to determine a flow direction of the target type of data on the link.

2. The method of claim 1, wherein the link comprises a link of a node called in response to a user request.

3. The method of claim 2, wherein detecting the field associated with the target type of data in the data traffic comprises:
detecting an identifier of the user request in the data traffic, to determine a transmission link of the identifier of the user request as the link of the node called in response to the user request; and
detecting the field associated with the target type of data on the transmission link.

4. The method of claim 1, wherein the data traffic comprises a traffic sample associated with a second node on the link, the traffic sample comprising at least one of a request, a response, a calling party, a service name, a function or a path associated with the second node.

5. The method of claim 4, wherein detecting the field associated with the target type of data in the data traffic comprises:
detecting the field associated with the target type of data in the traffic sample.

6. The method of claim 1, wherein detecting the field associated with the target type of data in the data traffic comprises:
detecting the field associated with the target type of data in the data traffic, based on a value of a target field associated with the target type of data in the first node.

7. The method of claim 1, further comprising:
in response to determining that the target type of data flows through a second node on the link, storing information about the second node and a field associated with the target type of data in the second node.

8-14. (canceled)

15. An electronic device, comprising:
at least one processing unit; and
at least one memory coupled to the at least one processing unit and storing instructions for execution by the at least one processing unit, the instructions, when executed by the at least one processing unit, causing the electronic device to perform acts comprising:
determining a link of a called node associated with a first node, wherein a target type of data flows through the first node;
obtaining data traffic on the link; and
detecting a field associated with the target type of data in the data traffic, to determine a flow direction of the target type of data on the link.

16. (canceled)

17. The electronic device of claim 15, wherein the link comprises a link of a node called in response to a user request.

18. The electronic device of claim 17, wherein detecting the field associated with the target type of data in the data traffic comprises:
detecting an identifier of the user request in the data traffic, to determine a transmission link of the identifier of the user request as the link of the node called in response to the user request; and
detecting the field associated with the target type of data on the transmission link.

19. The electronic device of claim 15, wherein the data traffic comprises a traffic sample associated with a second node on the link, the traffic sample comprising at least one of a request, a response, a calling party, a service name, a function or a path associated with the second node.

20. The electronic device of claim 19, wherein detecting the field associated with the target type of data in the data traffic comprises:
detecting the field associated with the target type of data in the traffic sample.

21. The electronic device of claim 15, wherein detecting the field associated with the target type of data in the data traffic comprises:
detecting the field associated with the target type of data in the data traffic, based on a value of a target field associated with the target type of data in the first node.

22. The electronic device of claim 15, the acts further comprise:
in response to determining that the target type of data flows through a second node on the link, storing information about the second node and a field associated with the target type of data in the second node.

23. A computer-readable storage medium having a computer program stored thereon, the program, when executed by a processor, implementing a method comprising:
determining a link of a called node associated with a first node, wherein a target type of data flows through the first node;
obtaining data traffic on the link; and
detecting a field associated with the target type of data in the data traffic, to determine a flow direction of the target type of data on the link.

24. The computer-readable storage medium of claim 23, wherein the link comprises a link of a node called in response to a user request.

25. The computer-readable storage medium of claim 24, wherein detecting the field associated with the target type of data in the data traffic comprises:
detecting an identifier of the user request in the data traffic, to determine a transmission link of the identifier of the user request as the link of the node called in response to the user request; and
detecting the field associated with the target type of data on the transmission link.

26. The computer-readable storage medium of claim 23, wherein the data traffic comprises a traffic sample associated with a second node on the link, the traffic sample comprising at least one of a request, a response, a calling party, a service name, a function or a path associated with the second node.

27. The computer-readable storage medium of claim 26, wherein detecting the field associated with the target type of data in the data traffic comprises:
detecting the field associated with the target type of data in the traffic sample.

28. The computer-readable storage medium of claim 23, wherein detecting the field associated with the target type of data in the data traffic comprises:
detecting the field associated with the target type of data in the data traffic, based on a value of a target field associated with the target type of data in the first node.
